(19) United States
(12) Patent Application Publication
(10) Pub. No.: US 2013/0311500 A1
(43) Pub. Date: Nov. 21, 2013

(54) SYSTEM AND METHOD FOR OPTIMIZING DATA ACQUISITION BASED ON COMMUNITY AND TIME PERIOD OPTIMIZATION

(71) Applicant: Article One Partners Holdings, New York, NY (US)

(72) Inventors: Cheryl Anne Milone, New York, NY (US); Peter Vanderheyden, New York, NY (US); Raymond Felts, New York, NY (US)

(73) Assignee: Article One Partners Holdings, New York, NY (US)

(21) Appl. No.: 13/895,108

(22) Filed: May 15, 2013

Related U.S. Application Data
(60) Provisional application No. 61/647,386, filed on May 15, 2012.
(60) Provisional application No. 61/652,468, filed on May 29, 2012.

(51) Int. Cl. G06F 17/30

(52) U.S. Cl. CPC G06F 17/30289
USPC 707/758

(57) ABSTRACT

The present disclosure presents embodiments including methods and apparatuses for technology timeline management and research community organization. For example, the present disclosure presents a method of database management, which includes receiving an input data from an entity, wherein the input data has an associated date range and technology type, populating a technology timeline with the input data based on the date range and technology type, and presenting the technology timeline to one or more members of the research community. The disclosure further presents a method of organizing members of a research community, which includes creating a hierarchy of community tiers, wherein the hierarchy of community tiers includes a first tier and one or more higher tiers, placing all new members of the research community into the first tier, and relocating a member of the research community from the first tier to the one or more higher tiers based on research performance.

### CLAIM OF PRIORITY

The present application claims priority to U.S. Provisional Patent Application No. 61/647,386, entitled “System and Method for Optimizing Data Acquisition Based on Community and Time Period Optimization,” and filed on May 15, 2012. Additionally, the present application claims priority to U.S. Provisional Patent Application No. 61/652,468, entitled “System and Process for Improving Patent Quality at the USPTO,” filed on May 29, 2012. These provisional applications are hereby incorporated by reference in their entirety.

### TECHNICAL FIELD

Embodiments described herein pertain generally to prior art searching. Some embodiments relate to optimizing data acquisition for prior art searching.

### BACKGROUND

Systems and services exist that are designed to help people remember personal information. An example of such a service is Evernote provided by Evernote Corporation of Mountain View, Calif. Some examples of the types of information that can be stored in Evernote are: clips from web sites, business cards, emails, documents, meeting notes, reminders, photographs (personal, landscapes, wine labels, etc.), wish-lists, receipts, audio notes, etc. Evernote lets users capture and retrieve any type of information using custom software running on a desktop or laptop computer, telephone, tablet, PDA or smartphone. Alternatively, Evernote also has a web-application which gives users access to their stored information without having to install any software. Once information is in Evernote, users can search for it using any combination of time, date, geo-location, tags, content attributes or keywords. Evernote also automatically identifies and indexes the printed and handwritten words inside of images.

Some entities aggregate data, such as prior art, for companies or individuals that owns or are otherwise interested in a piece of intellectual property (e.g., a patent, trademark, copyright, or trade secret). These companies and individuals may wish to search for prior art related to the subject matter of the intellectual property. By surveying the landscape of relevant prior art, these companies or individuals may make informed business decisions, such as whether to apply for a patent on a given invention, whether producing and/or selling a product would expose the company to a potential infringement suit, or whether to challenge a patent that serves as an obstacle for market entry.

Because some companies or individuals are inexperienced with the process of prior art searching, a bevy of professional prior art search firms and independent prior art searchers have emerged to serve the market need for these services. However, rather than pay the relatively expensive hourly or lump-sum fees charged by these professional searchers, some companies or individuals have chosen to “crowdsource” their prior art search needs.

In crowdsourcing, a community of independent, unrelated searchers each attempts to find prior art relevant to a piece of intellectual property (or a currently unprotected invention) in response to the company or individual posting a prior art search and related reward or price. However, few tools currently exist to aid this community of researchers in developing a fundamental understanding of the technological landscape and the related timeline of innovation that led to the current state of the art. Thus, methods of providing organized researching tools, such as technological development timelines, for a community of researchers are needed.

### SUMMARY

The present disclosure presents methods, systems, and apparatuses for managing a technology timeline and related database and for organizing members of a research community that may populate and utilize the technology timeline for research. For example, the present disclosure presents a method of database management, which includes receiving an input data from an entity, wherein the input data has an associated date range and technology type, populating a technology timeline with the input data based on the date range and technology type, and presenting the technology timeline to one or more members of the research community. The entity can be, for example, a company, an individual, or a member of the research community.

Additionally, the present disclosure presents a method of organizing members of a research community that includes creating a hierarchy of community tiers, wherein the hierarchy of community tiers includes a first tier and one or more higher tiers, placing all new members of the research community into the first tier; and relocating a member of the research community from the first tier to the one or more higher tiers based on research performance. Of course, in some circumstances, some embodiments can place new members into higher tiers, if they have already demonstrated certain skills.

Moreover, the present disclosure presents an apparatus for managing a database, comprising one or more modules configured to perform the acts of receiving an input data from an entity, wherein the input data has an associated date range and technology type, populating a technology timeline with the input data based on the date range and technology type, and presenting the technology timeline to one or more members of the research community.

Furthermore, the present disclosure presents an apparatus for organizing members of a research community, comprising one or more modules configured to perform the acts of creating a hierarchy of community tiers, wherein the hierarchy of community tiers includes a first tier and one or more higher tiers, placing all new members of the research community into the first tier, and relocating of a member of the research community from the first tier to the one or more higher tiers based on research performance.

In addition, the present disclosure presents at least one machine readable medium comprising a plurality of instructions that, in response to being executed on a computing device, cause the computing device to perform the acts of receiving an input data from an entity, wherein the input data has an associated date range and technology type, populating a technology timeline with the input data based on the date range and technology type, and presenting the technology timeline to one or more members of the research community.

Furthermore, the present disclosure presents at least one machine readable medium comprising a plurality of instructions that, in response to being executed on a computing device, cause the computing device to perform the acts of creating a hierarchy of community tiers, wherein the hierarchy of community tiers includes a first tier and one or more higher tiers, placing all new members of the research community into the first tier, and relocating of a member of the research community from the first tier to the one or more higher tiers based on research performance.

The above examples of the present disclosure present merely examples that will be further described and expanded in the detailed description and in view of the figures presented below.

### BRIEF DESCRIPTION OF THE DRAWINGS

FIG. 1 illustrates a schematic diagram illustrating a system for managing a technology timeline and organizing members of a research community, according to an example embodiment;

FIG. 2 illustrates a diagram of the structure of a technology timeline according to an example embodiment;

FIG. 3 illustrates a block diagram of a technology timeline manager according to an example of the disclosure;

FIG. 4 illustrates a flow diagram illustrating an example methodology for technology timeline management;

FIG. 5 illustrates a diagram of the structure of a member hierarchy according to an example embodiment;

FIG. 6 illustrates a block diagram of a member organizing manager according to an example of the disclosure;

FIG. 7 illustrates a flow diagram illustrating an example methodology for member organization; and

FIG. 8 illustrates a block diagram illustrating a machine in the example form of a computer system.

### DETAILED DESCRIPTION

The present disclosure presents methods and apparatuses for managing a technology timeline and one or more databases housing the technology timeline and for organizing members of an online community. In an example, a technology timeline according to the present disclosure may include technology descriptions that are organized from generic to more specific levels of detail organized on a chronological basis and, in one embodiment, built as a function of publications or publicly available information to build the framework. The technology timeline framework can be built on macro and micro levels, with the highest level of generic description of the technology being a macro level and a more descriptive level of the technology as a micro level. This technology timeline may be stored via an online database that may be amended by one or more members. In a further aspect, the one or more members may be organized according to one or more characteristics, such as technological experience, duration of membership.

Additionally, embodiments include analyzing input data to a technology timeline platform, evaluating existing data and identifying connections between the data to provide data trending, data relationships and data connections to provide otherwise latent information. For example, identifying multiple authors of a relevant publication as also publishing in disparate technology areas can indicate relevance of the disparate technology areas to one another.

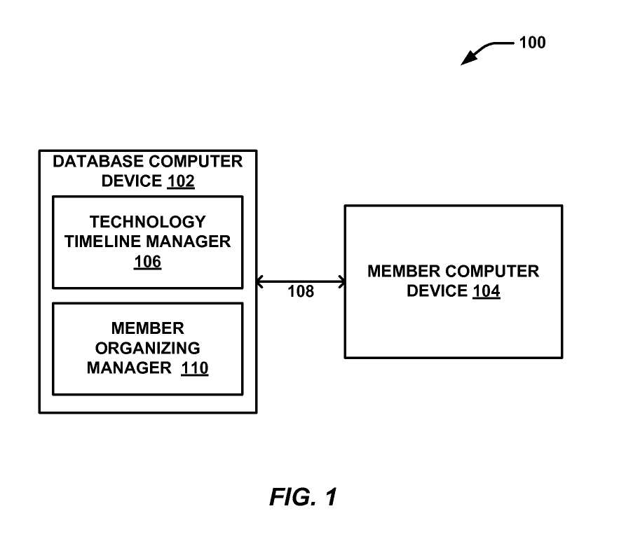

Turning to the figures, FIG. 1 is a schematic diagram illustrating a system 100 for organizing a community of researchers and for managing a technology timeline and related database according to an example embodiment. FIG. 1 includes an example member computer device 104, which may communicate with a database computer device 102 over a communication link 108.

In an aspect, the member computer device 104 may be a stationary computer device, such as, but not limited to, a personal computer, desktop computer, or the like. Additionally or alternatively, member computer device 104 may be a mobile device, such as, but not limited to, a smartphone, cellular telephone, mobile phone, laptop computer, tablet computer, or other portable networked device. In addition, member computer device 104 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a terminal, a user agent, a mobile client, a client, or some other suitable terminology. In general, the member computer device 104 may be small and light enough to be considered portable or may be relatively stationary and immobile.

In a further aspect, database computer device 102 of FIG. 1 may include one or more of any type of computer database device, such as a server, blade system, or any other computer device capable of data storage and/or processing. In an example, database computer device 102 may include a technology timeline manager 106, which may be configured to manage a technology timeline that may be presented to and/or amended by members of a research community via one or more member computer devices 104. Furthermore, database computer device 102 may include a member organizing manager 110, which may be configured to organize the one or more members of the research community.

Additionally, database computer device 102 may communicate with the one or more member computer devices 104 via communication link 108, which may include one or more wireless and/or core networks, such as, but not limited to, wide-area networks (WAN), wireless networks (e.g., 802.11 or cellular network), the Public Switched Telephone Network (PSTN) network, ad hoc networks, personal area networks (e.g., Bluetooth) or other combinations or permutations of network protocols and network types. Such network(s) may include a single local area network (LAN) or wide-area network (WAN), or combinations of LANs or WANs, such as the Internet.

Additionally, such network(s), which may comprise a W-CDMA system, and may communicate with one or more member computer devices 102 according to this standard. As those skilled in the art will readily appreciate, various aspects described throughout this disclosure may be extended to other telecommunication systems, network architectures and communication standards. By way of example, various aspects may be extended to other UMTS systems such as TD-SCDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 or later WiFi communication standards, IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system. The various devices coupled to the network(s) (e.g., member computer device 104 and/or database computer device 102) may be coupled to the network(s) via one or more wired or wireless connections.

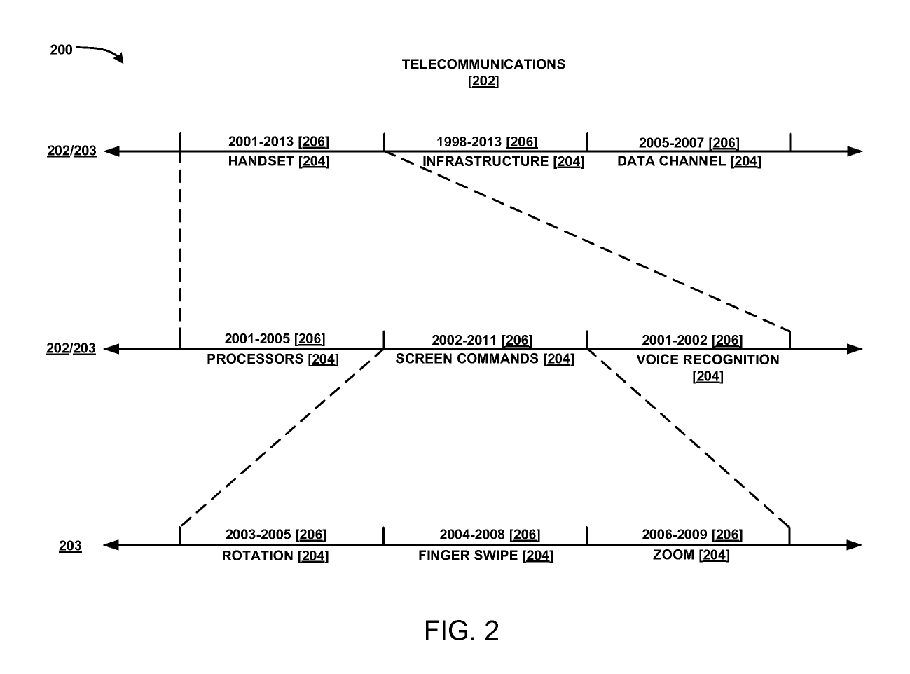

FIG. 2 is a diagram illustrating an example technology timeline 200 according to an aspect of the present disclosure. In some examples, the technology timeline 200 may comprise one or more macro levels 202, which may be divided into one or more technology types 204 and corresponding date ranges 206, such that input data added to the timeline and stored in an associated database may be easily organized, accessed, and utilized by members of a research community. In an additional aspect, each of the one or more technology types 204 and/or date ranges 206 may have an associated micro level 203 for further delineation and organization inside of the micro level 203, such that, in an essence, the micro level 203 becomes a macro level 202 for the technology types and/or date ranges included inside of the delineated area.

The technology timeline 200 can be generated by establishing as a starting point a technology subject matter and/or a range of dates or date along a chronological technology subject matter line (or a timeline). The lines relate to the technology subject matter level of description or abstraction. For example, as shown in FIG. 2, subject matter and timelines related to telecommunications as the highest or macro level 202 of abstraction, with a date range 206 applicable to the start of telecommunications with a continuation through some point in time (e.g., the present or some point in the past or future). The lines can apply through the present and projections for future developments (for example, an improvement available with a greater level of capacity of presently known components). In the example illustrating telecommunications, macro level 202 has associated subsections, or micro levels 203, of “handset,” “infrastructure,” and “data channel” with date ranges for each subsection. For the handset, one subset can include “screen commands,” which may further include a micro level that includes a subset for “finger swipe.”

Added to the subject matter and date lines can be events with similar ranges and dates, such as development of the technology at a certain university or company, the persons involved in the endeavor, an award won for the subject matter, patents granted, licensed, valuation events, company purchases, legal events, claim element interpretations, industry recognition, litigations, legal decisions effecting technology subject matter or patents, persons within an event range or date. This data related to members of the research community or input data can be applied at the most precise detail of technology subject matter (e.g. micro levels) and then to the increasing levels of abstraction (e.g., macro levels).

Based on the data content framework, when any input data is added to the platform, the starting point may be to identify ranges, dates, and events along the technology timeline related to the input data. Existing data can be used to further inform the input data. This approach can be self-expanding in that templates can be applied to determine the most efficient application of data to the technology subject matter and technology timelines in order to provide an output that both increases the value of the technology subject matter and timelines and meets the objective(s) of applying the input to the platform. Examples of input may be to crowdsource patent research or other questions to the community for the community to provide answers.

For example, a database or technology timeline manager may post a question or assignment for the research community. Even before presenting the question to the community, the technology subject matter and timelines can be accessed to gather any range or data about the input data, inform the objective, and then provide the informed input to the next step in the process to achieve the objective, such as to ask the community a question. The community also can search the technology timeline applied their own aggregation of resources to gain more value out of the technology subject matter related to the question or search. Every interaction with the technology timelines can provide an opportunity for the user to build the content of the technology timeline and the corresponding database or databases.

Other example objectives related to the technology timeline 200 can be to determine the future developments of a technology, provide data for valuation information, community adding their own personal libraries and tags and relationship to the technology timeline so that the build out of the platform can enable more efficient searching by the community using personal libraries of other community members. One incentive structure that can be applied is where a community member creates a library and provides pointers or tags to the researcher's publications to drive identification of the publication, and then the source community library creator receives compensation.

In one embodiment, the data (technology subject matter, levels of abstraction of the subject matter, ranges of dates, people, companies, entities involved in the technology, publications providing this information, formal and formally recognized records of the information, personal data and substantiating public data to support it, financial and deal flow transactions having to do with the technology, exemplary developments in a related or analogous technology field where a pattern can be applied to the technology subject matter as the input, semi-formal information such as contemporaneously recorded information such as meeting notes from related meetings, as an example standards meetings). In one embodiment, any entry into the platform can be required to be published or from a publicly available source that is verifiable through public access. In alternative embodiments, the data can move from substantiated with the substantiation speaking for itself to more subjective information such as meeting notes and business materials that may not have an independent publication date.

In a platform where there is a consideration of maintaining confidentiality and presenting facts as opposed to opinions, such as a platform used to analyze legal information, the data enabled for the platform and database can be required to be publicly available information and/or published information with in one embodiment, a date associated with the publication and in alternative embodiments with the date derived from the publication or applied or derived from the publication in an informal manner. Portions of the publication can be highlighted to focus on the location within the publication where the data is found, but using only publicly available sources reduces risk of opinions, the platform can be built based on the notion that the evidence or publication speaks for itself. This also can apply to future developments' questions such as the future expected developments of technology. In one embodiment, publications can be screened to eliminate those that may have been prepared for the purpose of creating data which a community researcher can then use to earn compensation. Given the value of the self-generating platform, it may itself trigger the creation of publications relevant to the question. A more sophisticated approach is to encourage the analysis of technology addressed on the platform to generate new publications and to provide separate compensation for this activity.

The input, objectives and output of the platform, databases, also can provide trending data, including technology areas that are of timely interest to the market. Consequently, categorizing the date, type of input, objectives, answers and outputs can be tracked to provide further data about technology subject matter and/or related date ranges.

Similarly, a feedback loop to further inform the accuracy of the platform and database can be created so that the community is able to revisit past data connections to determine how accurate they were and to identify approaches to improve their accuracy. This can be a form of input scheduled based on the output and follow-up events expected or actual, such as the closeout of a study. The feedback can include data connections back to users and/or community researchers to prompt users of the technology timelines to provide more data built upon developments and to enrich the platform and/or databases. Incentives can be provided with every interaction, such as feedback data compensated by profit sharing points or interactions with the technology timeline can prompt initial and early or preferred access to activities such as research that provides direct compensation. Similarly, building up a library by a researcher where the tags and data connections enable the publication to be selected by any analysis of the platform or database on an automated basis or by any user (such as another community member) can provide additional compensation. Additionally, the community can provide verification or confirmation of the qualifications of other community members, and add additional publications identified by the verifier.

Making connections of data and presenting the connections as a basis to gain further input into the data content framework enables a continuous optimization of the data. Updates, which may be feedback data generated and added to the technology timeline by other members of the research community, may trigger further updates and opportunities for the community to optimize the data. Community researchers can also affirm the accuracy of data in the data content framework by indicating an agreement with a publication (such as with a checkbox or other icon to indicate positive affirmation) or an affirmation where multiple community researchers identify the same publication within the same context in the data content framework. This weighting function can add further credibility to the value of the data. Community researchers can also be requested to prioritize the information from the most valuable in order to provide additional affirmation on their colleagues input. These are forms of peer review, without the editorial opinion data that may be sensitive in a platform where users of the platform include those in a litigation or legal context. This is peer review crowdsourcing in which the crowd is able to maintain confidentiality of the information during their collaboration.

The presentation of data derived from the platform and database can include primary, supporting and subjective sources so that more input data can be added of a subjective nature, but it can be identified as such as separated from the objective data. In a platform to support answers to legal questions, subjective information may need to be limited. This platform and database approach also can create a new form of taxonomy. The taxonomy can evolve based on the input data inputted to the platform, such as creating new technology description paths, macro levels or micro levels, based on a more detailed level of technology description as the subject matter of the input data, research or output. When a more detailed level is created, a subset path is prepared and the publications and input data entered are populated along the detailed paths up to the more generic paths for the technology subject matter and time lines.

The use of crowdsourcing in response to answers to questions can be driven by input data entered both from the crowd and from the question and the compensation structure including direct compensation and indirect compensation about the profit sharing paid out on a systematic basis, as well as adjusting reward levels and timing of studies to drive the incentives based on variability in these factors.

The input data entered by the crowd can indicate: historical background as a proxy for competencies as a researcher, whether general or specific competencies in research, general or specific prior art researchers, technology or science background, type of academic and career experiences and approach to work (e.g., whether the community member has a component of research in their background) and geographic location (access to international languages or residence in geographical regions of relevance to the subject matter of the platform and database). Identifying individual background generally for researchers, then mapping out the likelihood of success in research based on the background and predictive modeling as the community grows to refine the prediction enables both assignment of researchers to categories where they are most likely to be successful and similarly to provide data about the types of community researchers to seek out as we build our community based on common background data that is shared by top researchers of a community. The registration process also can include tapping into broader data (e.g., for specific technology or science subject matter of particular input or research request to the community) such as linked in or resume data to connect the researchers to applicable studies.

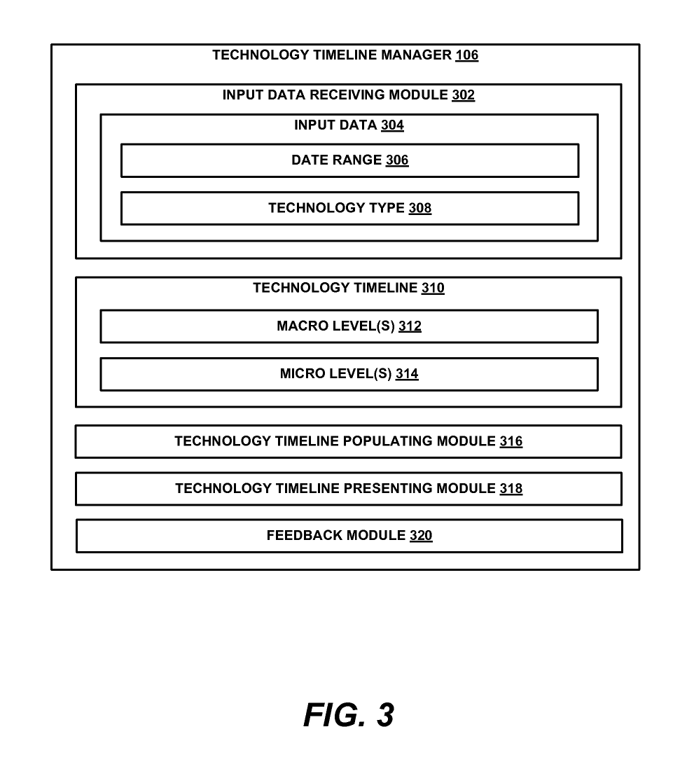

FIG. 3 is a block diagram illustrating an example technology timeline manager 106 of FIG. 1, which may be configured to manage one or more technology timelines that may be hosted by a database (e.g., database computer device 102 of FIG. 1) and updated by and/or presented to one or more members of a research community via a member computer device (e.g., member computer device 104 of FIG. 1). In an aspect, database computer device 102 may include an input data receiving module 302, which may be configured to receive one or more input data 304 from one or more member computer devices over a network. In some examples, the input data 304 may comprise a pointer to one or more online resources or copies of these online resources, which may include, but are not limited to, a web page, document, patent, patent application, non-patent literature, research paper, video, picture, advertisement, blog, web post, or any other information-presenting entity. Furthermore, in some examples, these input data may correspond to information related to a particular technology type 308 and date range 306, one or both of which may be the basis for the placement of the data of the input data 304 in technology timeline.

This placement, or “population,” may include identifying one or more macro levels 312 or micro levels 314 of the technology timeline 310 with which the input data 304 will be associated. Thus, in an aspect, technology timeline manager 106 may include a technology timeline populating module 316, which may be configured to populate technology timeline 310 by correlating the input data 304 to one or more macro levels 312 and/or micro levels 314. In some examples, technology timeline populating module 316 may populate technology timeline 310 by performing a write command to one or more data structures (e.g., arrays or other storage objects) or related memory associated with the database.

In an additional aspect, technology timeline manager 106 may include a technology timeline presenting module 318, which may be configured to present the technology timeline 310 to the one or more members of the research community. For example, technology timeline presenting module 318 may be configured to generate information, such as database rendering or web page code that may be transmitted to a member computer device such that the technology timeline may be presented to the member, for example, via a display device.

Furthermore, technology timeline manager 106 may include a feedback module 320, which may be configured to alter, overwrite, tag, or otherwise amend or supplement the content of technology timeline 310 based on member input, which may be received in some instances via an input data 304. For example, feedback module may be configured to add content to one or more macro levels 312, micro levels 314, or data content related to either.

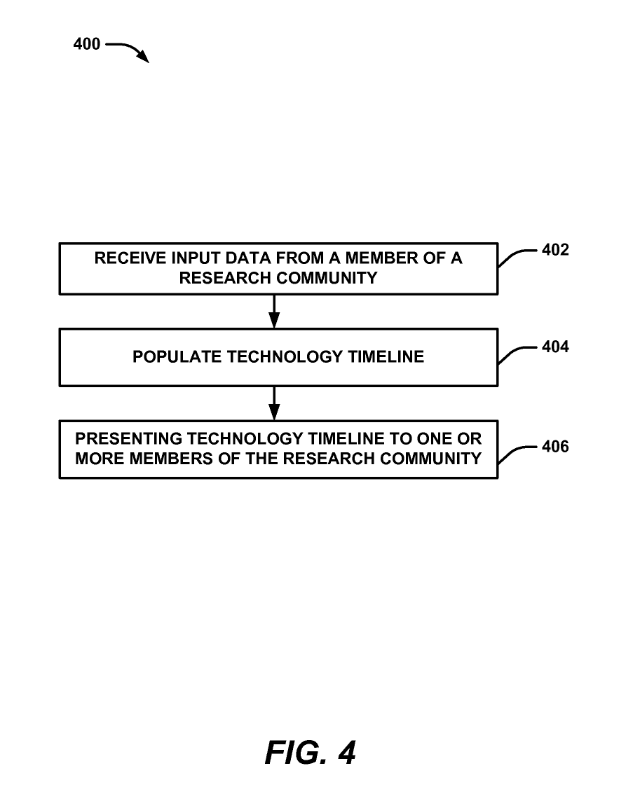

FIG. 4 presents an example methodology 400 for managing a technology timeline, which may include one or more acts, steps, or sub-methods associated with one or more non-exclusive blocks 402, 404, and 406. For example, methodology 400 may include, at block 402, receiving an input data from an entity. Additionally, the input data may comprise feedback related to existing data of the technology timeline. In an aspect, the research community may be a virtual, or online, research community of members each having a member computer device connected by a network. Additionally, methodology 400 may include populating a technology timeline at block 404 with the input data based on a date range and technology type associated with the input data. In an aspect, the technology timeline may be organized based on one or more macro levels and/or one or more micro levels associated with the one or more macro levels. Furthermore, each of the one or more macro levels may be comprised of one or more subsections, wherein each subsection has an associated micro level. In addition, the technology timeline may be hosted or otherwise located or controlled by a database computer device and may comprise a database, such as a cloud-based database. In an additional aspect, methodology 400 may include presenting the technology timeline to one or more members of the research community at block 406. This may include transmitting information or code to the one or more member computer devices, which may render a graphical representation of the technology timeline to the member via a display device in some examples.

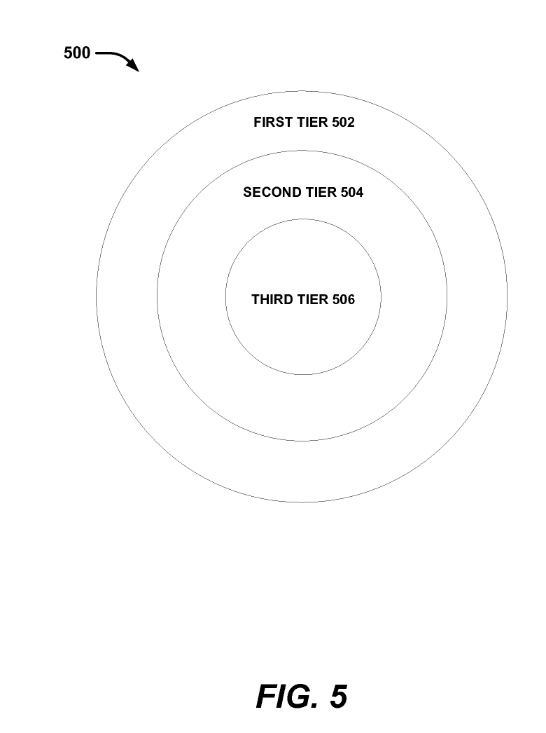

FIG. 5 illustrates an example community organization structure 500 associated with one or more research communities made up of one or more members. In an aspect, such research communities may be virtually assembled or connected and may be organized to provide research services, such as prior art searching services, for a requestor (e.g., a client, research firm, or research organizing entity).

For example, where the community is charged with patent research, the research task(s) may be said to be “crowdsourced.” According to one or more aspects presented herein, crowdsourcing patent research may be optimized for one or more client offerings with varying objectives, deliverables and reward levels. For each client offering, drive value by selecting one or more researcher qualities to align with the objectives of the client offerings. For each researcher quality, type of client offering and phase of participation of each researcher, providing the appropriate incentive. In an aspect, members of a community may be aggregated, organized, and/or optimized by providing incentives based on qualities of the community members aligned with the objectives of the crowdsourced work.

For example, for a community engaged in the subject matter of patent research, the intuitive value proposition may be to find international non-English language publications due to the limited translation of these publications into English and accessible in Western language based digitized databases.

Furthermore, the qualities of the community may include one or more of the following: a) whether the researcher is an individual or entity; b) the prior art research background of the researcher; c) the quality metrics associated with the researcher assigned based on continuing quality metrics; d) data about the researcher to match the value proposition for the client offering including geographic, technology or science subject matter of the, foreign language commitments, access to sources of references; and (e) the phase of participation of the researcher on an online platform and the impact on qualities (a) to (d) above based on a accumulating data and reassessment of the researcher.

Structure the compensation on a macro basis for one or more sets of client offerings and on a micro basis for each client offering, each project, each researcher, including researcher types such as individuals or entities to motivate the highest quality results. Plan for variations in incentives to promote the highest quality results for every researcher quality. For researchers that are entities, compensation may be structured to support individual researchers within the entity. The quality of the prior art collections can be optimized on a macro level from the entire community and then on a micro level for each study, assessed to drive input, and build the quality of output (e.g., search results).

FIG. 5 shows a distribution of community members within tiers based on their quality metric achievements, which include, but are not limited to, a first tier 502, a second tier 504, and a third tier 506. In an aspect, the tiers may represent increasing levels of achievement within the community. For example, new members may be placed in the first tier 502, whereas when a member achieves the highest level of quality, they may be placed in the third tier 506, which may include independent contract researchers who begin to receive guaranteed compensation.

Upon joining the community, the members can be placed into an entry status taking into account all of the data entered and amount of data and actual data which can be accessed by the crowd management platform—this entry status may include members of first tier 502. This status can control the application of the community to the platform as a default. The status can be changed by actual performance on the platform, such as winning studies, providing certain types of prior art (such as foreign language research which can be anticipated based on the geographical location of the researcher or data entered into the platform about languages which the research speaks) or other factors that demonstrate general or specific value propositions that can be tapped on any given study.

Each of the sources, e.g., community and technology subject matter, may be categorized based on macro and micro approaches, for example, by associating members or tiers of members with portions of a technology timeline or other characterization matrix, table, or structure. The macro community approaches, as one example, can apply to providing information to the entire community (e.g., all tiers), such as existing and even potential community members.

The micro community approach may use one or more historical quality metrics applied to community members to determine the likelihood of success on the input and, with a high likelihood of success, targeting one or more tiers (i.e. specific researchers) to provide answers to the current input question or existing data within the platform. During the feedback analysis of the database, additional narrow questions can be presented to one or a subset of community members (e.g., one or more tiers) to add greater value to the data content, such as a request for confirmation of the applicability of a disparate technology area identified above based on multiple authors of a publication where each author also has published in disparate technology areas. Another example of a question is to identify additional experts in the field of specific technology areas, such as for example, to ask the names of other academics where a researcher was an academic on the same technology subject matter.

An example approach is to cast a wide net on a macro level by querying all members of all tiers to provide data to answer the input question on the macro level of sources of data, and based on the data content, to tap more focused sources of data (e.g., researchers in second tier 504 or third tier 506) with close relationships to the technology subject matter to maximize the chance of providing a high quality answer to the input. The phases include input pre-studies, input new client study, and then weekly phases on a chronological basis as the collection in response to the studies develops.

As the phases for the launched study complete, the macro and micro levels of data for each phase provide the highest likelihood of receiving the highest quality information as early in the chronology of the technology subject matter as possible. For the administrator of the platform, receiving the highest quality answer to satisfy quality metrics as early in the process as possible reduces expenses needed to implement later actions. The administrators cost for the technology subject matter study or providing highest quality output in response to the input is minimized, resulting in a higher gross margin per project.

In addition, during the process, a record or scorecard is created of the output from the sources of data macro and micro from community and technology subject matter to create a record of the comprehensiveness of the output from the platform. The scorecard can be used to provide credibility of the highest quality response, particularly where, for example, a study with an objective of invalidity is completed where the patent is in fact valid. In this situation, a publication which comprehensively provides a technology description shown of the subject patent (or technology description of the subject patent) is not identified. The scorecard will demonstrate the comprehensiveness of the data to support that it is highly likely a publication was not found because one does not exist. This scorecard may constitute a portion of, or all of, one or more quality metrics that includes members and their scores, whereby ascension to a higher tier may be based on the quality metrics.

Additional approaches to optimize the quality of the responses may include structuring responsive data to align with highest value data adds recognized by quality metrics or members of the tiers of FIG. 5, which may be applied by the platform administrator and clients. For example, the community can be asked to provide a certain type of data in response to a study, such as only providing non-patent literature or, in a phased approach, providing only non-patent literature for a time period of the study. By enabling studies based on a crowd selection of funding those studies, the funding source are presenting an interest in the subject matter of the studies and therefore made the source is of information for responses. The notion of crowd funding studies, which are then crowd sourced to answer the subject matter of the study is another form of optimizing the platform.

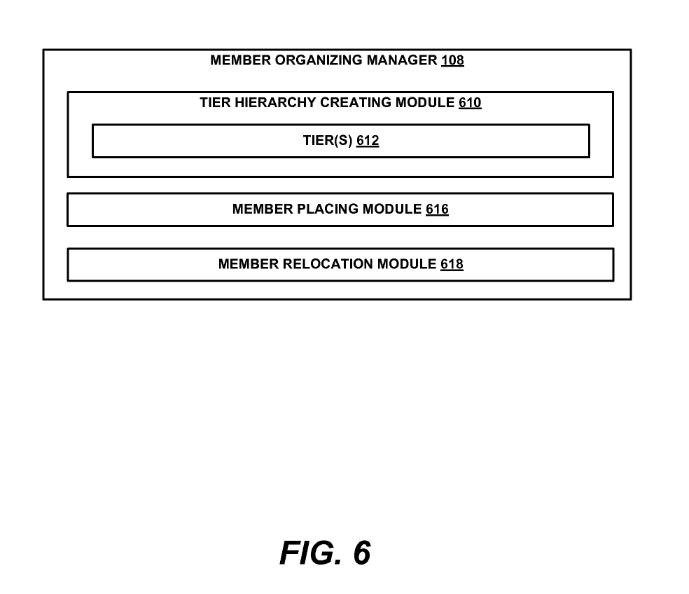

FIG. 6 is a block diagram illustrating aspects of a member organizing manager 108 of database computer device 102 of FIG. 1, which may be configured to manage member organization. In an aspect, member organizing manager 108 may include a tier hierarchy creating module, which may be configured to place one or more members of a research community into one or more tiers 612. In some examples, tiers 612 may include first tier 502, second tier 504, and/or third tier 506, as well as other tiers not shown in the figures. Additionally, in some examples, new and/or prospective members of a community may be placed in a first tier and first tier member may ascend to an upper tier (e.g., second or third tier) based on performance, expertise, or the like.

Member organizing manager 108 may therefore include a member placing module 616, which may be configured to place one or more members into the one or more tiers 612. For example, member placing module 616 may be configured to place one or more new community members into a first tier. Furthermore, member organizing manager 108 may include a member relocation module, which may be configured to relocate one or more members from one tier to a higher or lower tier, for example, based on one or more quality or performance metrics.

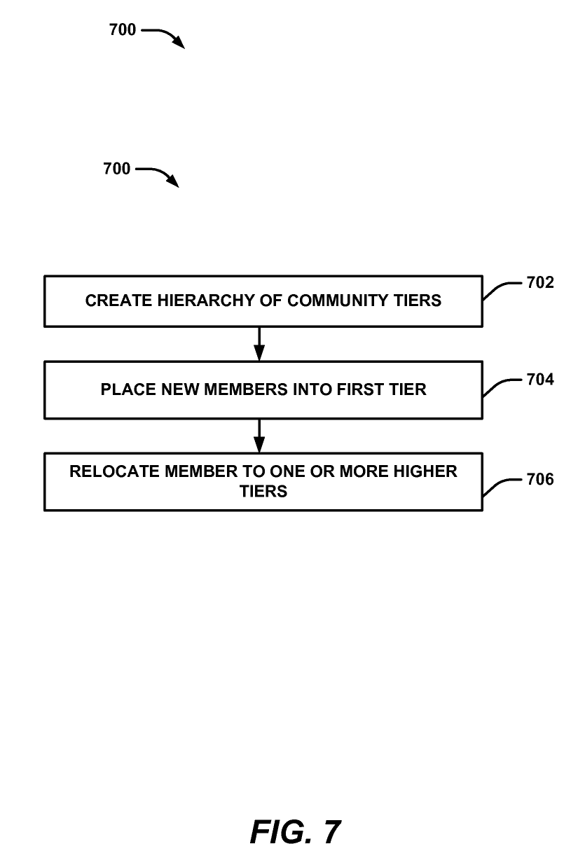

FIG. 7 presents an example methodology 700 for organizing members of a research community, which may include one or more acts, steps, or sub-methods associated with one or more non-exclusive blocks 702, 704, and 706. For example, methodology 400 may include, at block 702, creating a hierarchy of community tiers, which may include a first tier and one or more higher tiers. Furthermore, methodology 700 may include placing new members into the first tier at block 704. In addition, methodology 700 may include relocating one or more members to a different tier, such as a higher or lower tier, based on one or more quality metrics or performance metrics.

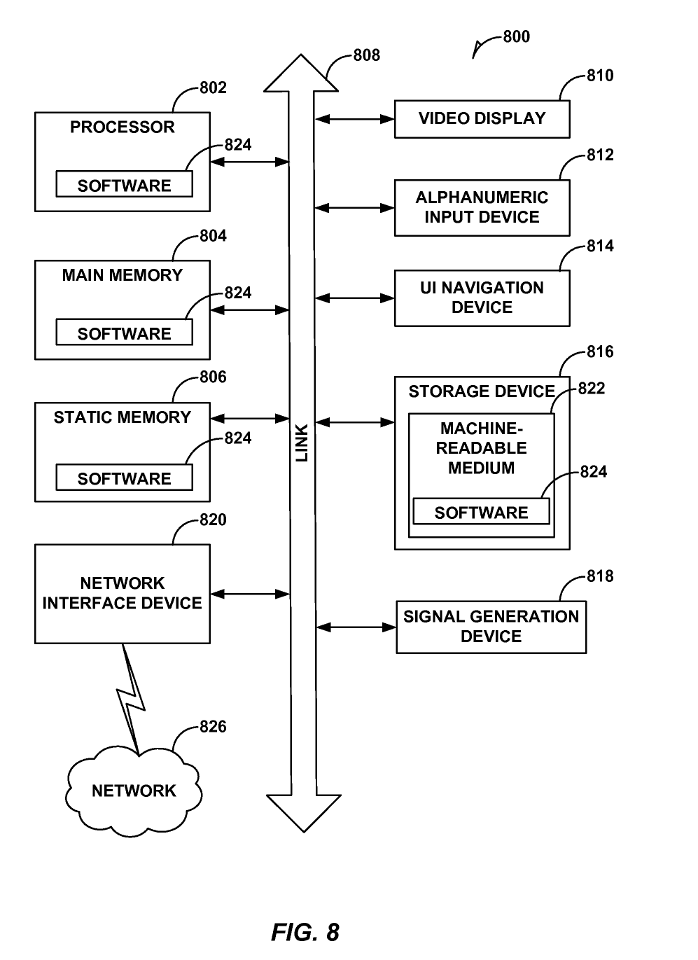

FIG. 8 is a block diagram illustrating a machine in the example form of a computer system 800, within which a set or sequence of instructions for causing the machine to perform any one of the methodologies discussed herein may be executed, according to an example embodiment. In alternative embodiments, the machine operates as a standalone device or may be connected (e.g., networked) to other machines. In a networked deployment, the machine may operate in the capacity of either a server or a client machine in server-client network environments, or it may act as a peer machine in peer-to-peer (or distributed) network environments. The machine may be a personal computer (PC), a tablet PC, a set-top box (STB), a Personal Digital Assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, which may include, for example, database computer device 102 and/or member computer device 104 of FIG. 1.

Example computer system 800 includes at least one processor 802 (e.g., a central processing unit (CPU), a graphics processing unit (GPU) or both, processor cores, compute nodes, etc.), a main memory 804 and a static memory 805, which communicate with each other via a link 808 (e.g., bus). The computer system 800 may further include a video display unit 810, an alphanumeric input device 812 (e.g., a keyboard), and a user interface (UI) navigation device 814 (e.g., a mouse). In one embodiment, the video display unit 810, input device 812 and UI navigation device 814 are incorporated into a touch screen display. The computer system 800 may additionally include a storage device 815 (e.g., a drive unit), a signal generation device 818 (e.g., a speaker), a network interface device 820, and one or more sensors (not shown), such as a global positioning system (GPS) sensor, compass, accelerometer, or other sensor.

The storage device 815 includes a machine-readable medium 822 on which is stored one or more sets of data structures and instructions 824 (e.g., software) embodying or utilized by any one or more of the methodologies or functions described herein. The instructions 824 may also reside, completely or at least partially, within the main memory 804, static memory 805, and/or within the processor 802 during execution thereof by the computer system 800, with the main memory 804, static memory 805, and the processor 802 also constituting machine-readable media.

While the machine-readable medium 822 is illustrated in an example embodiment to be a single medium, the term “machine-readable medium” may include a single medium or multiple media (e.g., a centralized or distributed database, and/or associated caches and servers) that store the one or more instructions 824. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including, by way of example, semiconductor memory devices (e.g., Electrically Programmable Read-Only Memory (EPROM), Electrically Erasable Programmable Read-Only Memory (EEPROM)) and flash memory devices; magnetic disks such as internal hard disks and removable disks; magneto-optical disks; and CD-ROM and DVD-ROM disks.

The instructions 824 may further be transmitted or received over a communications network 826 using a transmission medium via the network interface device 820 utilizing any one of a number of well-known transfer protocols (e.g., HTTP). Examples of communication networks include a local area network (LAN), a wide area network (WAN), the Internet, mobile telephone networks, Plain Old Telephone (POTS) networks, and wireless data networks (e.g., Wi-Fi, 3G, and 4G LTE/LTE-A or WiMAX networks). The term “transmission medium” shall be taken to include any intangible medium that is capable of storing, encoding, or carrying instructions for execution by the machine, and includes digital or analog communications signals or other intangible medium to facilitate communication of such software.

Examples, as described herein, can include, or can operate on, logic or a number of modules, modules, or mechanisms. Modules are tangible entities capable of performing specified operations and can be configured or arranged in a certain manner. In an example, circuits can be arranged (e.g., internally or with respect to external entities such as other circuits) in a specified manner as a module. In an example, the whole or part of one or more computer systems (e.g., a standalone, client or server computer system) or one or more hardware processors can be configured by firmware or software (e.g., instructions, an application portion, or an application) as a module that operates to perform specified operations. In an example, the software can reside (1) on a non-transitory machine-readable medium or (2) in a transmission signal. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, one instantiation of a module may not exist simultaneously with another instantiation of the same or different module. For example, where the modules comprise a general-purpose hardware processor configured using software, the general-purpose hardware processor can be configured as respective different modules at different times. Accordingly, software can configure a hardware processor, for example, to constitute a particular module at one instance of time and to constitute a different module at a different instance of time.

Additional examples of the presently described method, system, and device embodiments include the following, non-limiting configurations. Each of the following non-limiting examples may stand on its own, or may be combined in any permutation or combination with any one or more of the other examples provided below or throughout the present disclosure. The preceding description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments.

What is claimed is:

1. A method of database management, comprising:
receiving, at a processor, an input data from an entity, the input data having an associated date range and technology type;
populating, via the processor, a technology timeline with the input data based on the date range and technology type; and
presenting the technology timeline to one or more members of the research community.

2. The method of claim 1, wherein the technology timeline is organized based on one or more macro levels and one or more micro levels associated with each macro level.

3. The method of claim 2, wherein each of the one or more macro levels is comprised of one or more subsections, wherein each subsection has an associated micro level.

4. The method of claim 3, wherein each micro level has a corresponding date range and technology type.

5. The method of claim 1, wherein the technology timeline is accessible online to the members of the research community.

6. The method of claim 1, wherein the technology timeline is associated with a cloud-based database.

7. The method of claim 1, wherein members of the research community are able to amend an existing entry of the technology timeline.

8. The method of claim 1, wherein other members of the research community are able to rate the member based on the input data.

9. A method of organizing members of a research community, comprising:
creating a hierarchy of community tiers, wherein the hierarchy of community tiers includes a first tier and one or more higher tiers;
placing all new members of the research community into the first tier; and
relocating a member of the research community from the first tier to the one or more higher tiers based on research performance.

10. The method of claim 9, further comprising applying one or more quality metrics to determine whether to relocate the member to a higher tier.

11. An apparatus for managing a database, comprising one or more modules configured to perform the acts of:
receiving an input data from an entity, wherein the input data has an associated date range and technology type;
populating a technology timeline with the input data based on the date range and technology type; and
presenting the technology timeline to one or more members of the research community.

12. The apparatus of claim 11, wherein the technology timeline is organized based on one or more macro levels and one or more micro levels associated with each macro level.

13. The apparatus of claim 12, wherein each of the one or more macro levels is comprised of one or more subsections, wherein each subsection has an associated micro level.

14. The apparatus of claim 13, wherein each micro level has a corresponding date range and technology type.

15. The apparatus of claim 11, wherein the technology timeline is accessible online to the members of the research community.

16. The apparatus of claim 11, wherein the technology timeline is associated with a cloud-based database.

17. The apparatus of claim 11, wherein members of the research community are able to amend an existing entry of the technology timeline.

18. The apparatus of claim 11, wherein other members of the research community are able to rate the member based on the input data.

19. An apparatus for organizing members of a research community, comprising one or more modules configured to perform the acts of:
creating a hierarchy of community tiers, wherein the hierarchy of community tiers includes a first tier and one or more higher tiers;
placing all new members of the research community into the first tier; and
relocating a member of the research community from the first tier to the one or more higher tiers based on research performance.

20. The apparatus of claim 19, further comprising one or more modules configured to perform the act of applying one or more quality metrics to determine whether to relocate the member to a higher tier.

21. At least one machine readable medium comprising a plurality of instructions that, in response to being executed on a computing device, cause the computing device to perform the acts of:
receiving an input data from an entity, wherein the input data has an associated date range and technology type;
populating a technology timeline with the input data based on the date range and technology type; and
presenting the technology timeline to one or more members of the research community.

22. The at least one machine readable medium of claim 21, wherein the technology timeline is organized based on one or more macro levels and one or more micro levels associated with each macro level.

23. The at least one machine readable medium of claim 22, wherein each of the one or more macro levels is comprised of one or more subsections, wherein each subsection has an associated micro level.

24. The at least one machine readable medium of claim 23, wherein each micro level has a corresponding date range and technology type.

25. The at least one machine readable medium of claim 21, wherein the technology timeline is accessible online to the members of the research community.

26. The at least one machine readable medium of claim 21, wherein the technology timeline is associated with a cloud-based database.

27. The at least one machine readable medium of claim 21, wherein members of the research community are able to amend an existing entry of the technology timeline.

28. The at least one machine readable medium of claim 21, wherein other members of the research community are able to rate the member based on the input data.

29. At least one machine readable medium comprising a plurality of instructions that, in response to being executed on a computing device, cause the computing device to perform the acts of:
creating a hierarchy of community tiers, wherein the hierarchy of community tiers includes a first tier and one or more higher tiers;
placing all new members of the research community into the first tier; and
relocating a member of the research community from the first tier to the one or more higher tiers based on research performance.

30. The at least one machine readable medium of claim 29, further comprising one or more modules configured to perform the act of applying one or more quality metrics to determine whether to relocate the member to a higher tier.
